(19) United States
(12) Patent Application Publication
(10) Pub. No.: US 2011/0205336 A1
(43) Pub. Date: Aug. 25, 2011

(54) THREE-DIMENSIONAL IMAGE REPRODUCING APPARATUS

(75) Inventors: HIDEKI FUKUDA, Nara (JP); TOSHIYA NORITAKE, Osaka (JP)

(73) Assignee: PANASONIC CORPORATION, Osaka (JP)

(21) Appl. No.: 13/032,020

(22) Filed: Feb. 22, 2011

(30) Foreign Application Priority Data
Feb. 23, 2010 (JP) 2010-036796

(51) Int. Cl. H04N 13/00

(52) U.S. Cl. 348/43; 348/E13.002

(57) ABSTRACT

There is provided a reproducing apparatus that includes a separating unit operable to separate a three-dimensional image signal containing left-eye image data and right-eye image data into left-eye image data and right-eye image data, a decoder operable to decode the left-eye image data to output a left-eye image signal, and decode the right-eye image data to output a right-eye image signal, a first image quality adjustment unit operable to adjust image quality of an image indicated by the left-eye image signal, and a second image quality adjustment unit operable to adjust image quality of an image indicated by the right-eye image signal. Adjustment of the image quality of the image indicated by the left-eye image signal, which is performed by the first image quality adjustment unit, is performed independently from adjustment of the image quality of the image indicated by the right-eye image signal, which is performed by the second image quality adjustment unit.

### BACKGROUND

1. Technical Field

The technical field relates to an apparatus for reproducing a three-dimensional image.

2. Related Art

A three-dimensional image is composed of a left-eye image and a right-eye image captured with parallax. A three-dimensional image allows a user to feel three-dimensional with an image for the left eye viewed by the user seen with only the left eye and an image for the right eye viewed by the user with only the right eye.

As a method for efficiently compressing and coding image signals of such a three-dimensional image, MPEG4-MVC (Moving Picture Expert Group 4—Multiview Video Coding) format is known (see ISO/IEC 14496-10 (MPEG4-AVC)), which is achieved by extending Moving Picture Expert Group 4—Advanced Video Coding (MPEG4-AVC) format. In this format, one of the left and right images is defined as a base image and the other as an extension image. As with an ordinary two-dimensional image, the base image is compressed and coded by the MPEG4-AVC coding format. The extension image is efficiently compressed and coded by coding information about the difference based on the base image data. Coded base image data, created by compressing and coding the base image can be decoded to be output as a two-dimensional image signal. Accordingly, the base image can be reproduced as a two-dimensional image even by a reproducing apparatus that is not designed for reproduction of three-dimensional images.

Coded data on a base image and extension image compressed by the MPEG4-MVC coding format are packetized as an MPEG2 transport stream, multiplexed, transmitted, or recorded (see ISO/IEC 13818-1 (MPEG2 format)). Applying different packet identification (PID) signals to the base and extension packets enables these packets to be separated when reproduced.

### SUMMARY

When different image processings are done between the left-eye image and that for the right-eye image, as in the MPEG4-MVC coding format, coding deformation caused by compression is different between the right and left eyes coding. Consequently, difference in image quality between the left and right images becomes significant. If the image quality difference between the left and right images of the three-dimensional image is great, the three-dimensional view may be adversely affected.

To address the foregoing problem, it is an object to provide a reproducing apparatus that reproduces an image in which the image qualities of the left and right images of a three-dimensional parallax image are balanced.

A reproducing apparatus according to the present aspect includes, a separating unit operable to separate a three-dimensional image signal containing left-eye image data and right-eye image data into left-eye image data and right-eye image data, a decoder operable to decode the left-eye image data to output a left-eye image signal, and decode the right-eye image data to output a right-eye image signal, a first image quality adjustment unit operable to adjust image quality of an image indicated by the left-eye image signal, and a second image quality adjustment unit operable to adjust image quality of an image indicated by the right-eye image signal. Adjustment of the image quality of the image indicated by the left-eye image signal, which is performed by the first image quality adjustment unit, is performed independently from adjustment of the image quality of the image indicated by the right-eye image signal, which is performed by the second image quality adjustment unit.

In the reproducing apparatus according to the present aspect, the image quality of an image indicated by a left-eye image signal and the image quality of an image indicated by a right-eye image signal are independently adjusted by the first and second image quality adjustment units. For example, if one of the left and right images contains more noise than the other, the noise removal process is intensified for the image that contains more noise. Thereby, the image quality of this image can be matched to that of the other image. Thus, reproduction of a three-dimensional image in which image quality difference between the left and right eye images is lessened can be achieved.

### BRIEF DESCRIPTION OF DRAWINGS

FIG. 1 is a block diagram illustrating a reproducing apparatus according to Embodiment 1.

FIG. 2 is a block diagram illustrating a signal processing unit of the reproducing apparatus according to the Embodiment 1.

FIG. 3 is a block diagram illustrating image quality adjustment units of the reproducing apparatus according to the Embodiment 1.

### DETAILED DESCRIPTION OF PREFERRED EMBODIMENT

### Embodiment 1

A preferred embodiment will be described below.

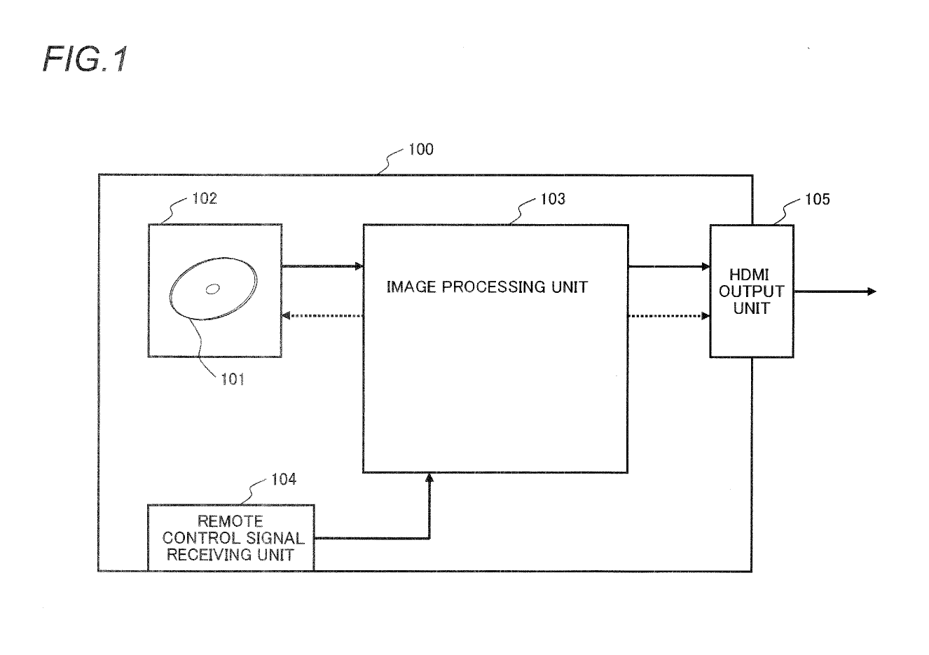

FIG. 1 is a block diagram illustrating a reproducing apparatus according to Embodiment 1. A description is given below of a reproducing apparatus that reproduces a recording medium on which three-dimensional image data compressed and coded by the MPEG4-MVC coding format are recorded.

Three-dimensional image data coded by the MPEG4-MVC coding format include base image coded data and extension image coded data. The base image coded data is data compressed and coded by the same format as the MPEG4-AVC coding format. The base image coded data is data for either one of left and right eye images. The extension image coded data is data that is produced by compressing and coding information on the difference between the left and right eye images. The extension image coded data is data for the other of the left and right eye images. Each of a packet of base image coded data and a packet of extension image coded data includes a Packet Identification Signals (PID) to distinguish whether the packet correspond to the packet of base image coded data or the packet of extension image coded data.

The reproducing apparatus 100 includes a disk drive unit 102, a signal processing unit 103, a remote control signal receiving unit 104, and a High-Definition Multimedia Interface (HDMI) output unit 105. This reproducing apparatus 100 reproduces a three-dimensional image signal recorded on a disk 101. The disk drive unit 102 reads data recorded on the loaded disk 101. The signal processing unit 103 decodes data read from the disk 101, generates a left-eye image signal and a right-eye image signal, and adjusts the image quality of each image indicated by the corresponding image signal. The HDMI output unit 105 outputs the left and right eye image signals supplied by the signal processing unit 103 through a digital interface such as an HDMI. The remote control signal receiving unit 104 receives a command output from a remote controller by an operation of a user, and then outputs this command to the signal processing unit 103. The signal processing unit 103 will be described in detail below.

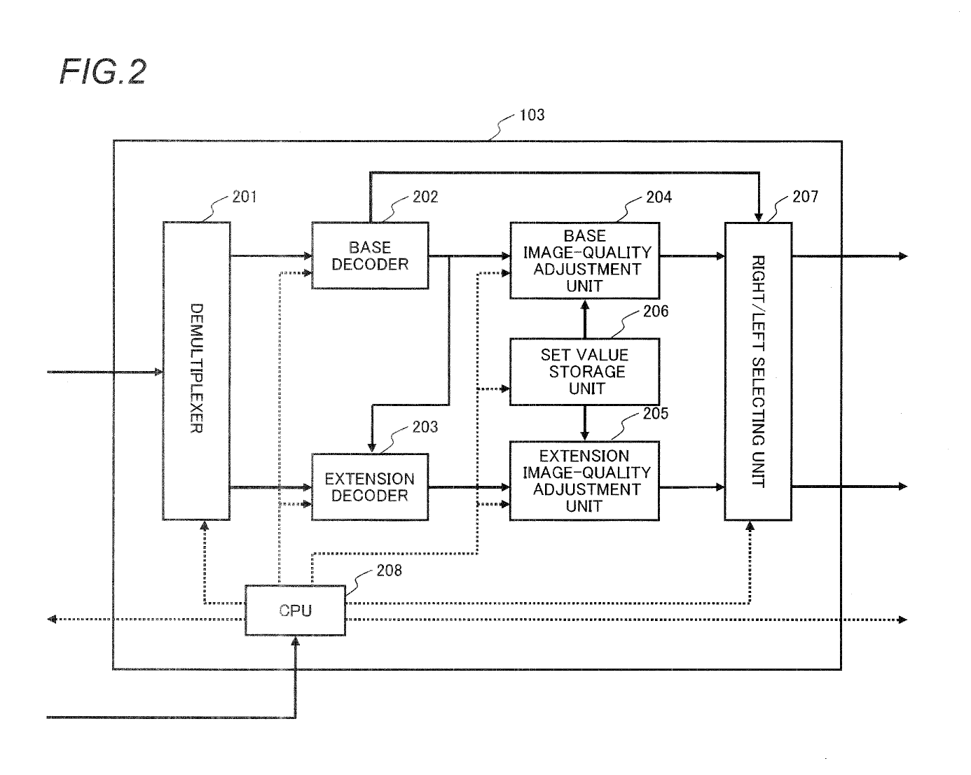

FIG. 2 is a block diagram illustrating the configuration of the signal processing unit 103. The signal processing unit 103 includes a demultiplexer 201, a base decoder 202, an extension decoder 203, a base image-quality adjustment unit 204, an extension image-quality adjustment unit 205, a set value storage unit 206, a right/left selecting unit 207, and a CPU 208.

Data read from the disk 101 in the disk drive unit 102 is input to the demultiplexer 201. The demultiplexer 201 separates three-dimensional image data into base image coded data and extension image coded data according to the identification signal (PID). The base decoder 202 decodes the base image coded data to output a base image signal. The extension decoder 203 decodes the extension image coded data, and generates an extension image signal from the decoded signal and the base image signal output from the base decoder 202, to output the generated extension image signal. In addition, the base decoder 202 detects a left/right identification flag included in the base image coded data. The left/right identification flag includes information for associating the base image signal with a signal indicating one of the left and right eye images and associating the extension image signal with a signal indicating the other. The base image-quality adjustment unit 204 adjusts the image quality of an image indicated by the base image signal according to an image quality adjustment parameter stored in the set value storage unit 206. The extension image-quality adjustment 205 adjusts the image quality of an image indicated by the extension image signal. The set value storage unit 206 stores an image quality adjustment parameter used for adjusting the image quality of a base image, an image quality parameter used for adjusting the image quality of an extension image, and an image quality adjustment parameter used for adjusting the image quality of a two-dimensional image. Based on the left/right identification flag detected by the base decoder 202, the left/right selecting unit 207 associates the base image signal with one of the left and right eye images, and associates the extension image signal with a signal indicating the other of the left and right eye images. For example, the left/right selecting unit 207 associates the base image signal with the left-eye image and associates the extension image signal with the right-eye image respectively based on the left/right identification flag. The left/right selecting unit 207 outputs the associated base image signal as one of the left and right eye image signals and the extension image signal as the other. The CPU 208 processes a command that the remote control signal receiving unit 104 received from the remote controller, thereby controlling each of compositional element of the signal processing unit 103.

To reproduce a two-dimensional image signal in the signal processing unit 103, an operation similar to the case where an extension image signal for a three-dimensional image is absent is performed. Specifically, a two-dimensional image signal is decoded by the base decoder 202, and the image quality thereof is adjusted by the base image-quality adjustment unit 204.

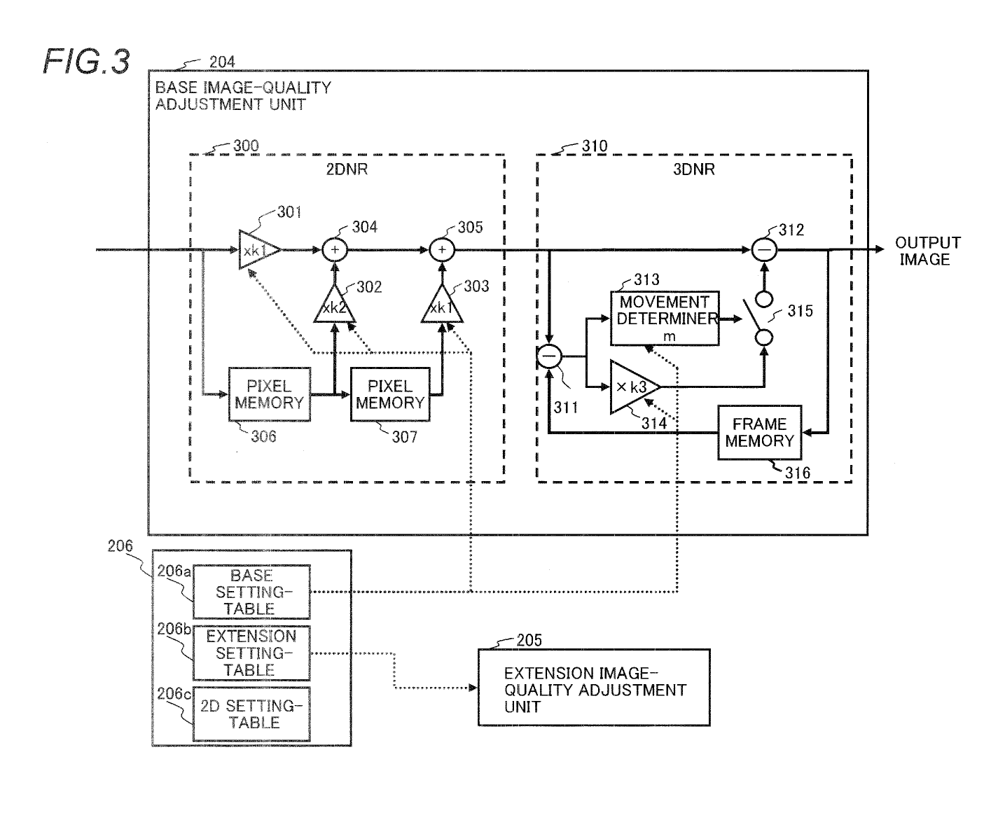

FIG. 3 is a block diagram of an example of the configuration of the base image-quality adjustment unit 204. The base image-quality adjustment unit 204 includes a two-dimensional noise removal section 300 for removing planar noise generated in an image (i.e., frame), and a three-dimensional noise removal section 310 for removing temporal noise generated between images (i.e., frames). The extension image-quality adjustment unit 205 has same configuration as the base image-quality adjustment unit 204. Parameters (coefficients k1, k2, k3, m) for the compositional elements of the base image-quality adjustment unit 204 and extension image-quality adjustment unit 205 can be independently set.

The two-dimensional noise removal section 300 is a Finite Impulse Response (FIR) filter with two taps, which includes multipliers 301, 302, and 303, adders 304 and 305, and pixel memories 306 and 307.

In the two-dimensional noise removal section 300, the first and last pixel values of three successive pixels input from the base decoder 202 are multiplied by the coefficient k1 by the multipliers 301 and 303 respectively, and the pixel value of the middle pixel is multiplied by the coefficient k2 by the multiplier 302, and the pixel values thus multiplied by these coefficients k1 and k2 are added together, thereby removing planar noise. The noise removal method as described above is a typical method for removing planar noise generated in an image. The value of each of the coefficients k1 and k2 indicates the intensity of the noise removal process. That is, as the value of k2 is greater than that of k1, the intensity of the noise removal process becomes lower. Further as the closer the ratio of k1 is closer to k2, the intensity of the noise removal process becomes higher. The values of the coefficients k1 and k2 for the corresponding multipliers 301, 302 and 303 are stored in the set value storage unit 206. Table 1 shows an example of noise removal intensities and the values of the coefficients k1 and k2.

TABLE 1

| Noise removal intensity | k1 | k2 |
|---|---|---|
| High | 5/16 | 6/16 |
| Intermediate | 3/16 | 10/16 |
| Low | 1/16 | 14/16 |
| Off | 0 | 1 |

The three-dimensional noise removal section 310 includes subtracters 311 and 312, a movement determiner 313, a multiplier 314, a switch 315, and a frame memory 316. This three-dimensional noise removal section 310 performs a noise removal process of movement adaptive type in the direction of a time axis.

The three-dimensional noise removal section 310 performs a three-dimensional noise removal process only for an area in which movement does not take place, in an image. The three-dimensional noise removal section 310 calculates the difference between the pixel value of a pixel currently input and the pixel value of a pixel in the previous frame (one frame before), and the multiplier 314 multiplies the difference by the coefficient k3. The pixel value of the pixel in the previous frame immediately is given by the frame memory 316. Subsequently, the three-dimensional noise removal section 310 subtracts the value of the difference multiplied by the coefficient k3 from the pixel value of the input pixel, thus removing the noise. The value of the coefficient k3 is given by the set value storage unit 206. The noise removal method as described above is a typical method for removing temporal noise generated in an image.

The movement determiner 313 of the three-dimensional noise removal section 310 determines the degree of image movement not to remove noise from an image that substantially moving. Specifically, the movement determiner 313 calculates the difference between the pixel values of the identical pixel in different frames and compares this difference with a threshold value (m). If the difference is equal to or smaller than the threshold value (m), the movement determiner 313 determines that the movement is small, then turns on the switch 315 to remove noise from the pixel. If the difference is larger than the threshold value (m), the determiner 313 determines that the movement is great, and then turns off the switch 315 not to remove noise from the pixel. In the foregoing configuration, if the value of the threshold value (m) is made greater, the frequency at which image movement is determined to be great decreases. Accordingly, the noise removal process is performed more frequently, thereby obtaining the enhanced effectiveness of noise removal.

Table 2 shows examples of the noise removal intensity of the three-dimensional noise removal section 310, and the coefficient k3 and threshold value (m). In this case, the pixel level has 256 gradations.

TABLE 2

| Noise removal intensity | k3 | m |
|---|---|---|
| High | 1/4 | 4 |
| Intermediate | 1/4 | 2 |
| Low | 1/8 | 2 |
| Off | 0 | 0 |

The set value storage unit 206 stores tables for specifying the coefficients k1, k2, and k3 and threshold value (m), which are used in the noise removal process performed by the two-dimensional noise removal section 300 and three-dimensional noise removal section 310. As the tables, three types tables of a base setting-table 206a, an extension setting-table 206b, and a 2D setting-table 206c are provided. The base setting-table 206a specifies the coefficients k1, k2, and k3 and threshold value (m) used in the image quality adjustment process performed for the base image of a three-dimensional image by the base image-quality adjustment unit 204. The extension setting-table 206b specifies the coefficients k1, k2 and k3 and threshold value (m) used in the image quality adjustment process performed for an extension image of a three-dimensional image by the extension image-quality adjustment unit 205. The 2D setting-table 206c specifies the coefficients k1, k2, and k3 and threshold value (m) used in image quality adjustment process for a two-dimensional image by the base image-quality adjustment unit 205. Table 3 shows examples of the coefficients k1, k2, and k3 and threshold value (m) specified each table.

TABLE 3

| | Image | Noise removal | | | | |
|---|---|---|---|---|---|---|
| Table | signal | intensity | k1 | k2 | k3 | m |
| Base | Base image | Low | 1/16 | 14/16 | ⅛ | 2 |
| setting- | of 3D image | | | | | |
| table | | | | | | |
| Extension | Extension | Inter- | 3/16 | 10/16 | ¼ | 2 |
| setting- | image of 3D | mediate | | | | |
| table | image | | | | | |
| 2D setting- | 2D image | Low | 1/16 | 14/16 | ⅛ | 2 |
| table | | | | | | |

In the present embodiment, adjustment of the image qualities of a base image indicated by the base image signal is performed independently from adjustment of the extension image indicated by the extension image signal, thereby matching the image qualities of left-eye and right-eye images, and hence obtaining a high quality three-dimensional image.

To reproduce a three-dimensional image signal, data read from the disk 101 in the disk drive unit 102 is separated into base image coded data and extension image coded data by the demultiplexer 201. The base image coded data is decoded by the base decoder 202. The extension image coded data is decoded by the extension decoder 203 The base image signal output from the base decoder 202 is subjected to image quality adjustment by the base image-quality adjustment unit 204. The extension image signal output from the extension decoder 203 is subjected to image quality adjustment by the extension image-quality adjustment unit 205. The image quality of an image indicated by the base image signal is adjusted based on an image quality adjustment parameter provided for a base image, which are specified in the base setting-table 206a of the set value storage unit 206. Likewise, the quality of an image indicated by the extension image signal is adjusted based on an image quality adjustment parameter provided for an extension image, specified in the extension setting-table 206b stored in the set value storage unit 206. In the present embodiment, noise removal intensity for the base image signal is set to “Low” and that for the extension image signal is set to “intermediate.” In other words, the noise removal intensity for the extension image signal is made higher than that for the base image signal. In addition, to reproduce a standard two-dimensional image signal, the noise removal intensity is set to “LOW,” as in the case of the base image signal indicating the three-dimensional image. That is, the adjustment of the image quality of the image indicated by the image signal decoded from the base image coded data is identical to adjustment of image quality of an image indicated by a two-dimensional image signal.

An explanation will now be given of why the noise removal intensity for the base image signal is set higher than that for the extension image signal as described above. Generally, a base image obtained by MPEG4-MVC coding is less noisy and of higher quality than an extension image. This is because although the extension image signal is generated by estimating and coding a base image signal, deformation of the extension image signal, resulting from compression coding, tends to be greater than that of the base image signal. That is, the extension image signal is noisier than the base image signal. Any difference in image quality between the left and right eye images may result in degradation of a three-dimensional view. To address the foregoing problem, in the present embodiment, the base image-quality adjustment unit 204 and the extension image-quality adjustment unit 205 adjust the image qualities so that the image quality of the image indicated by the left-eye image signal is identical to the image quality of the image indicated by the right-eye image signal are identical. Specifically, the present embodiment makes the noise removal intensity for a base image signal higher than that for an extension image signal. Such a configuration balances, for example, the degrees of deformation of the left and right eye images, resulting from compression coding, and hence enables reproduction of a three-dimensional image of high quality.

Incidentally, in the present embodiment, the signal processing unit 103 may include a sharpening means such as one that enhances a specific frequency band width together with the base image-quality adjustment unit 204 and extension image-quality adjustment unit 205, which remove noise in the manner described above. In this case, as well as noise removal intensity for an extension image signal being set higher, the sharpening process is intensified. The sharpening process is intensified in order to prevent the following situation. That is, when noise removal intensity is increased, the high frequency band components of an image decrease, leading to a blurred image. Intensifying the sharpening process as in the manner described above enables a balancing of the qualities of the base and extension images, i.e., a left-eye image and right-eye image (hereinafter referred to as “left and right images” if necessary).

In the foregoing, noise removal was given as an example of an image quality adjustment function. However, the image quality adjustment function is not limited thereto. The image quality adjustment function may have the adjustment of image quality such as brightness, contrast, color density, color tone, or sharpness.

For example, sharpness may be adjusted. Specifically, since an extension image signal is produced by being estimated from a base image signal, the high frequency band components of an image may decrease due to deformation resulting from compression coding. This may lead to a blurred image. Therefore, the extension image signal is sharpened more than the base image signal, thereby balancing the left and right image qualities. Alternatively, the image qualities of a base image and extension image (i.e., left and right images) may be balanced by decreasing the high frequency band components of the base image signal and then matching the band of the base image signal to the band of the extension image signal.

Alternatively, the image qualities of a base image and extension image (left and right images) may be balanced by detecting the average luminance levels of the base image and extension image, and adjusting the brightness of the base image and that of the extension image so that the average luminance levels thus detected are equal.

Alternatively, the image qualities of a base image and extension image (left and right images) may be balanced by measuring the luminance level distributions of the base and extension images, and adjusting the brightness and contrast of the base and extension of the extension images so that the luminance level distributions are identical.

Alternatively, the image qualities of a base image and extension image (left and right images) may be balanced by detecting the chroma levels of the base and extension images, and adjusting the color density and color tone so that the chroma levels thus detected are identical.

The luminance and chroma levels thus detected are feedback controlled and the image qualities are adjusted to eliminate image quality difference between the base and extension images. Thus, the image qualities of the base and extension images (left and right images) can be balanced.

Further, the image qualities of images indicated by a base image signal and an extension image signal may independently be adjusted by user setting. For instance, a value set by a user based on a signal received by a remote control signal reception unit 104 may be processed by the CPU 208, and then a set parameter stored in the set value storage unit 206 may be changed. This enables a user to freely set the image qualities of images indicated by the base and extension image signals. Accordingly, the image qualities of a base image and extension image (i.e., left and right images) can be adjusted to suit user preference.

Additionally, setting for image quality adjustment for a base image signal indicating a three-dimensional image may be identical to that for image quality adjustment for reproduction of a two-dimensional image signal. Thus, the image quality of an image reproduced from a recording medium on which two-dimensional image signals are recorded is set to be identical to that of an image reproduced from a recording medium on which three-dimensional image signals are recorded. This suppresses image quality difference resulting from the difference in type between the images to be reproduced.

In the embodiment 1, a description was given using an example where an image to be reproduced has been an image compressed and coded by the MPEG4-MVC coding format. However, the image is not limited to this type, and the process is widely available for a three-dimensional image containing left-eye image data and right-eye image data.

Incidentally, examples of a format for a three-dimensional image recorded on the disk 101 include a side-by-side format and top-and-bottom format other than the MPEG4-MVC coding format. Whether the format for a three-dimensional image recorded on the disk 101 is the side-by-side format, top-and-bottom format, or MPEG4-MVC coding format may be determined from image signal information or decoded information. In the present embodiment, which one of the formats is used may be determined by checking image signal information or decoded information in the demultiplexer 201. Here, the format for a three-dimensional image recorded on the disk 101 is an image format such as the side-by-side format or top-and-bottom format, in which both left and right eye images are recorded on one screen page, the image qualities of the left and right eye images recorded on the disk are generally identical (i.e., they are adjusted in advance so as to be identical). In this case, the image qualities of the left and right eye images may be adjusted so as to be identical. Specifically, if a format for a three-dimensional image recorded on the disk 101 is recognized as a side-by-side format or top-and-bottom format in the demultiplexer 201, the base decoder 202 may perform a decoding process for both left and right eye image data, and then the base image-quality adjustment unit 204 may perform the image quality adjustment process according to a parameter recorded in the set value storage unit 206.

The reproducing apparatus according to Embodiment 1 has been described using an example where a three-dimensional image signal recorded on a recording medium is reproduced. However, the idea of Embodiment 1 is not limited to this and may be used to reproduce a three-dimensional image signal received via a transmission line such as broadcasting.

The foregoing reproducing apparatus 100 according to Embodiment 1 separately has the base decoder 202 for decoding base image coded data and the extension decoder 203 for decoding extension image coded data. However, the base decoder 202 and extension decoder 203 do not have to be mounted separately. Specifically, instead of base decoder 202 and extension decoder 203, a decoder may be mounted for decoding and outputting both base image coded data and extension image coded data.

The foregoing reproducing apparatus 100 according to Embodiment 1 includes the base image-quality adjustment unit 204 and extension image-quality adjustment unit 205. However, these adjustment units 204 and 205 do not have to be mounted separately. That is, instead of the image-quality adjustment unit 204 and extension image-quality adjustment unit 205, an integrated means may be mounted to adjust the image qualities of both an image indicated by a base image signal and an image indicated by an extension image signal.

In the foregoing reproducing apparatus 100 according to the Embodiment 1, base image coded data contains a left/right identification flag, and the base decoder 202 detects this flag. However, it may be that the extension image coded data contains the left/right identification flag. In this case, the left/right identification flag is detected by the extension decoder 203. In addition, the left/right selecting unit 207 receives the left/right identification flag from the extension decoder 203. Alternatively, both the base image coded data and extension image coded data may include the left/right identification flag.

In the foregoing reproducing apparatus 100 according to Embodiment 1, base image coded data corresponds to left-eye image data, and expansion coded data corresponds to right-eye image data. However, the base image coded data may correspond to the right-eye image data, and the expansion coded data may correspond to the left-eye image data.

In the Embodiment 1, the image output unit outputs data according to an HDMI format but it may output data according to other formats. That is, any other format capable of outputting a three-dimensional image may be adapted.

In the MPEG4-MVC coding format, whether there is any image quality difference between the left and right eye images can be recognized by a coded parameter. Additionally, the degree of noise or blur of an image can be recognized by the information from the decoder, for example, a coded parameter or the amount of code. Therefore, noise removal intensity or the like, for example, may be adjusted by detecting these parameters.

### INDUSTRIAL APPLICABILITY

The reproducing apparatus according to the present embodiment reproduces a three-dimensional image in which the difference between the left and right image qualities is lessened. Accordingly, the reproducing apparatus can be used as, for example, a reproducing apparatus for a recording medium on which a three-dimensional image is recorded or a reproducing apparatus for reproducing streaming data for a three-dimensional image transferred via a network.

What is claimed is:

1. A reproducing apparatus comprising:
a separating unit operable to separate a three-dimensional image signal containing left-eye image data and right-eye image data into left-eye image data and right-eye image data;
a decoder operable to decode the left-eye image data to output a left-eye image signal, and decode the right-eye image data to output a right-eye image signal;
a first image quality adjustment unit operable to adjust image quality of an image indicated by the left-eye image signal; and
a second image quality adjustment unit operable to adjust image quality of an image indicated by the right-eye image signal;
wherein adjustment of the image quality of the image indicated by the left-eye image signal, which is performed by the first image quality adjustment unit, is performed independently from adjustment of the image quality of the image indicated by the right-eye image signal, which is performed by the second image quality adjustment unit.

2. The reproducing apparatus according to claim 1, wherein the first and second image quality adjustment units adjust the image qualities so that the image quality of the image indicated by the left-eye image signal is identical to the image quality of the image indicated by the right-eye image signal are identical.

3. The reproducing apparatus according to claim 1, wherein one of the left-eye image data and the right-eye image data of the three-dimensional image signal is base image coded data which is obtained by coding a base image, and the other image data is extension image coded data which is obtained by coding information about difference between the left and right eye images.

4. The reproducing apparatus according to claim 3, wherein each of the first and second image quality adjustment units includes a section operable to remove noise from the image signals, and wherein noise removal intensity for the image signal decoded from the extension image data is higher than that for the image signal decoded from the base image data.

5. The reproducing apparatus according to claim 3, wherein the adjustment of the image quality of the image indicated by the image signal decoded from the base image coded data, made by the first or second image quality adjustment unit, is identical to adjustment of image quality of an image indicated by a two-dimensional image signal, made by the first or second image quality adjustment unit.

6. The reproducing apparatus according to claim 1, wherein when the three-dimensional image signal is an image signal of a side-by-side format or top-and-bottom format, either one of the first and second image quality adjustment units makes same image quality adjustment for both the image indicated by the left-eye image signal and the image indicated by the right-eye image signal.
